(19) United States
(12) Patent Application Publication
(10) Pub. No.: US 2009/0129324 A1
(43) Pub. Date: May 21, 2009

(54) COMMUNICATION SYSTEM AND COMMUNICATION METHOD

(75) Inventor: Takeshi Soneda, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/049,752

(22) Filed: Mar. 17, 2008

(30) Foreign Application Priority Data
Nov. 21, 2007 (JP) 2007-301247

(51) Int. Cl. H04Q 7/00

(52) U.S. Cl. 370/329

(57) ABSTRACT

A communication apparatus and method including scanning all of channels, specifying, based on a result of the scanning, at least other communication apparatus which is wirelessly connectable and a channel for a wireless connection to the other communication apparatus, a table based on corresponding information of a communication apparatus and a channel for a corresponding wireless connection and information of the other communication apparatus and the channel specified, and transmitting the information table to a mobile apparatus, where the mobile apparatus receives the table and controls wirelessly connecting the channel to the other communication apparatus using the table received.

### CROSS-REFERENCE TO RELATED APPLICATIONS

This application is related to and claims priority to Japanese patent application No. 2007-301247 filed on Nov. 21, 2007, in the Japan Patent Office, the entire contents of which are incorporated by reference herein.

### BACKGROUND

1. Field

The present technology relates to a wireless LAN system in which a client (a mobile terminal and the like) is connected with a plurality of access points, and more particularly, to a method and system enabling a client to efficiently search for an access point most appropriate for the client.

2. Description of the Related Art

In recent years, wireless LAN communication using electric waves, infrared ray or the like has been in widespread use and the market for wireless LAN is growing. Since the wireless LAN makes it possible to provide a freely moveable terminal, demand for wireless LAN has increased not only in companies but also in households.

A specification of the wireless LAN is standardized by IEEE (the Institute of Electrical of Electronic Engineers) 802.11. There are specifications of IEEE 802.11a and IEEE 802.11b as an extended specification of IEEE 802.11.

IEEE 802.11a is a new specification capable of communicating at speeds up to 54 Mbps and uses a frequency band of 5 GHz. IEEE 802.11b is a standard specification of the wireless LAN and is most commonly used today. IEEE 802.11b is a specification capable of communicating at speeds up to 11 Mbps and uses a frequency band of 2.4 GHz.

Generally, in a wireless LAN, communication is established by connecting an access point to a client which is a mobile terminal device by electric wave. In this case, an “access point” as used in the wireless LAN refers to a transponder (wireless station) connected to the LAN.

The access point transmits a beacon signal in order to indicate the existence thereof. The client performs scanning (searching) for beacon signals.

In a wireless LAN connection compliant with IEEE 802.11a, a frequency of the beacon signal is determined for each channel (CH) from CH 1 to CH 8. In the wireless LAN connection compliant with IEEE 802.11b, a frequency of the beacon signal is determined for each channel (CH) from CH 1 to CH 14. Thus, a total number of 22 CHs are specified for the wireless LAN. Further, 11 kinds of CHs will be added to IEEE 802.11a in the future. Therefore, 11 kinds of CHs are added to the existing total of 22 CHs, so that the wireless LAN provides a total of 33 CHs. Each access point transmits, through the air, the beacon signal of the CH which is set for the access point itself.

The client sequentially scans for the beacon signals of the total of 33 CHs transmitted from the access points. When receiving an electric wave of a certain CH, the client determines the kind of the CH, stops the scanning operation, and connects to the access point (AP).

FIG. 9 is a flow chart showing a connecting operation of a typical wireless LAN. When moving to a wireless area of an access point, a client determines whether or not it is a scan timing (operation S81). In this case, the scan timing is not determined during a time the client is scanning for beacon signals, a time the client is receiving an electric wave of a certain CH from the access point, and a time the client is connecting to the access point.

In operation S81, if the client determines that it is the scan timing, the client sequentially scans for all of the CHs from the CH 1 to CH 33 transmitted from the access point. (operation S82). On the other hand, if the client determines that it is not the scan timing at operation S81, the connection operation repeats determination of whether it is the scan timing.

If the client receives an electric wave of a connectable CH and detects the access point, the client stops the scanning operation, updates information of the connectable access point and comes to be wirelessly connected to the access point (operation S83).

If the access point is wirelessly connected to a plurality of the clients, the access point is connected to each of the plurality of the clients wirelessly.

Moreover, in recent years, at the time of wireless connection between the access point and the client, the client has used a Received Signal Strength Indicator (RSSI) of the access point. Determination is made of whether or not the RSSI value is greater than a predetermined threshold value TH.

If RSSI value>TH, the client is in a state capable of connecting wirelessly to the access point. If RSSI value<TH, the client is not in a state capable of obtaining a good communication quality.

If the client sequentially scans for all of the CHs from CH 1 to CH 33, a scanning time of 200 msec per channel is required to obtain all of the beacon signals. Accordingly, if the client scans for all of the CHs, a non-communication time of slightly more than 6 seconds arises.

As described above, if a long non-communication time arises frequently, there may be a problem including a case where an application being used by a client suddenly stops or the like, which causes an unstable operation.

When a mobile terminal device is locked to be used, the client scans for an unnecessary CH even though the mobile terminal device is locked to be used because the client scans for all of the CHs, which causes an inefficient operation.

The present technology addresses problems including those described above and obtains a stable connection between a client and an access points by reducing a non-communication time at a time of scanning, and provides a communication system and a communication method in order to make scanning of channel(s) (CHs) more efficient.

### SUMMARY

The disclosed communication system and method includes scanning for all of channels, specifying, based on a result of the scanning, other communication apparatus which is wirelessly connectable and a channel corresponding thereto for wireless connection, a table based on corresponding information of a communication apparatus and a respective channel and corresponding information of the other communication apparatus and the channel specified, and transmitting information table to a mobile apparatus. The mobile apparatus receives the table and controls wireless connection of the channel to the other communication apparatus.

The disclosed mobile apparatus of the communication system performs a logical sum operation on information tables transmitted respectively from a plurality of the communication apparatuses, and wirelessly connects the channel to the other communication apparatus of the information table on which the logical sum operation is performed.

The communication apparatus and method includes determining strength of an electric wave of a channel, and edits the channel which is determined to have a strength of an electric wave which is greater than a predetermined threshold value.

According to the disclosed communication system and method, at least the following effect can be obtained. There is no need for a client to scan for all of the CHs at all times, thereby reducing the scanning time by scanning only necessary channels. If the scanning time is reduced, more time is allowed for transmission and reception of real data. As a result, it is possible to achieve efficient band usage.

Further, by recognizing all of the channels of the plurality of the communication apparatuses to which the client can be connected, it is possible to obtain an operation having high-stability (highly reliable) for the client in order to be wirelessly connected to the plurality of the access points.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a configuration diagram illustrating a wireless LAN system.

FIG. 2 is a connection relationship diagram illustrating a client connected with access points of a wireless LAN system.

FIG. 3 is a configuration diagram illustrating an access point.

FIG. 4 is a configuration diagram illustrating a memory unit of an access point.

FIG. 5 is a configuration diagram illustrating a client.

FIG. 6 is a flow chart illustrating a processing procedure of an access point.

FIG. 7 is a flow chart illustrating a processing procedure of a client.

FIG. 8 is a diagram illustrating an operational sequence of a client and an access point.

FIG. 9 is a flow chart illustrating a connecting operation of a typical wireless LAN.

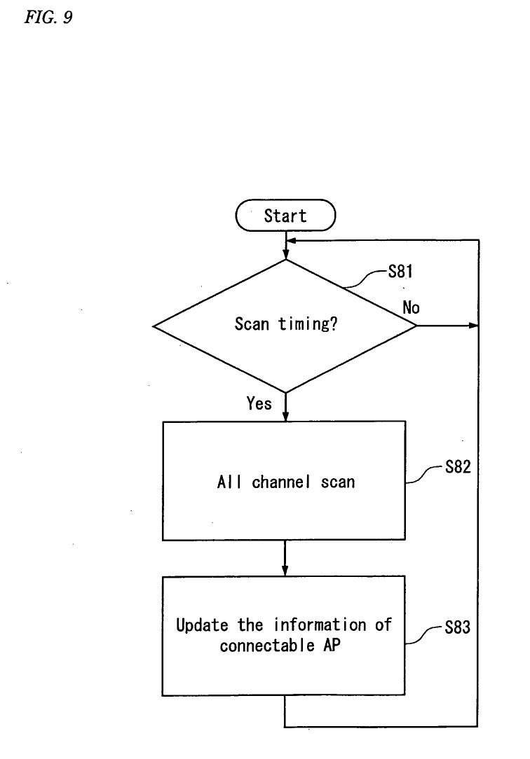

### DETAILED DESCRIPTION OF THE EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

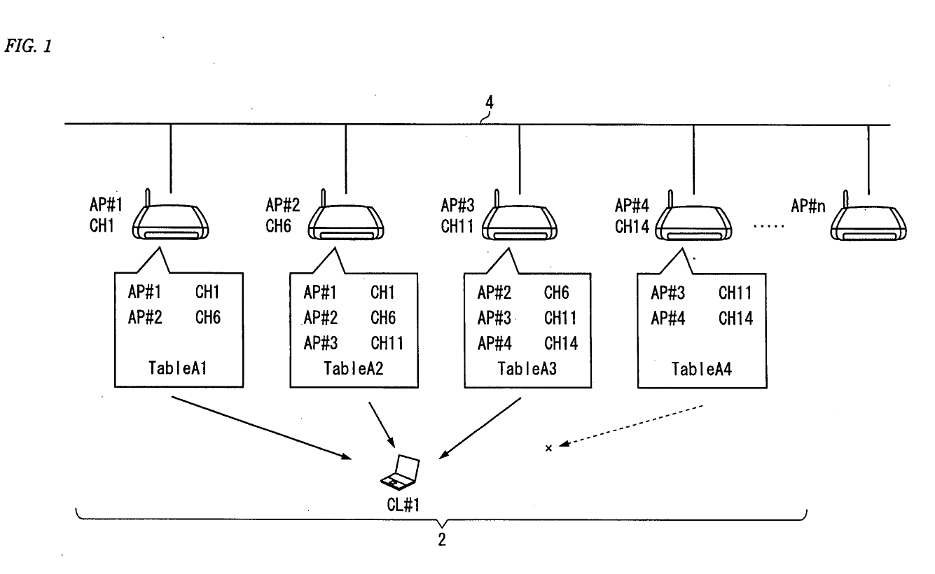

Description will now be made of an embodiment of the present technology, with reference to FIG. 1. FIG. 1 is a configuration example of a wireless LAN system according to an embodiment.

The wireless LAN system 2 is an example of a wireless communication system in which a plurality of access points are wirelessly connected to a terminal device (client) CL#1 and applies to a notebook type computer as the terminal device. The wireless LAN system 2 is provided with access points AP#1, AP#2, . . . AP#n as a plurality of wireless communication apparatuses. These access points AP#1, AP#2, . . . AP#n are connected with a network through a LAN cable 4 and are in a relationship of sharing information. These access points AP#1, AP#2, . . . AP#n receive a connection request from the client CL#1 and are capable of a wireless connection within a predetermined number of connection(s). The access points AP#1, AP#2, . . . AP#n serve as base stations to the client CL#1. The client CL#1 is composed of an information processing terminal device such as a personal computer equipped with a wireless connection function. The present technology performs wireless scanning of all of the CHs to determine which CH is to be used.

In the wireless LAN system 2, in the case of FIG. 1, the access point AP#1 scans for all of the CHs and makes (creates) a table A1 of the CHs which can be connected to access point(s) existing around the access point AP#1. A table includes each item storing information indicating an access point and information indicating a respective channel, respectively. For example, the table A1 stores information of access point AP#1 and corresponding channel CH1, and access point AP#2 and corresponding channel CH6. The access point AP#1 notifies the client CL#1 of the information of the table A1.

In the same way, the access point AP#2 scans for all of the CHs and makes a table A2 of the CH(s) which can be connected to the access points existing around the access point AP#2. The table A2 stores information of access point AP#1 and channel CH1, access point AP#2 and channel CH6, and access point AP#3 and channel CH11. The access point AP#2 notifies the client CL#1 of the information of the table A2.

In the same way, the access point AP#3 scans for all of the CHs and makes a table A3 of the CH(s) which can be connected to the access point existing around the access point AP#3. The table A3 stores information of access point AP#2 and channel CH6, access point AP#3 and channel CH11, and access point AP#4 and channel CH14. The access point AP#3 notifies the client CL#1 of the information of the table A3.

In the same way, the access point AP#4 scans for all of the CHs and makes a table A4 of the CH(s) which can be connected to the access point existing around the access point AP #4. The table A4 stores information of access point AP#3 and channel CH11, and access point AP#4 and channel CH14. The access point AP#4 notifies the client CL#1 of the information of the table A4.

As described above, each of the access points AP#1, AP#2, . . . AP#n scans for all of the CHs and makes a table A of the CH(s) which can be connected to other access point(s) existing around the access point. The table A at the access point stores CH information which can be received by the client. The access point notifies the client of the information of the table A.

According to an embodiment, in the wireless LAN system, signals transmitted from an access point are arranged all over an area around the access point without being overlapped. Consequently, in a case where strength of a signal transmitted from a neighboring access point is increased, the table stores the information of the neighboring access point as shown in the previously described table A. Also, the present technology performs scanning of the CH both at the access points and the clients.

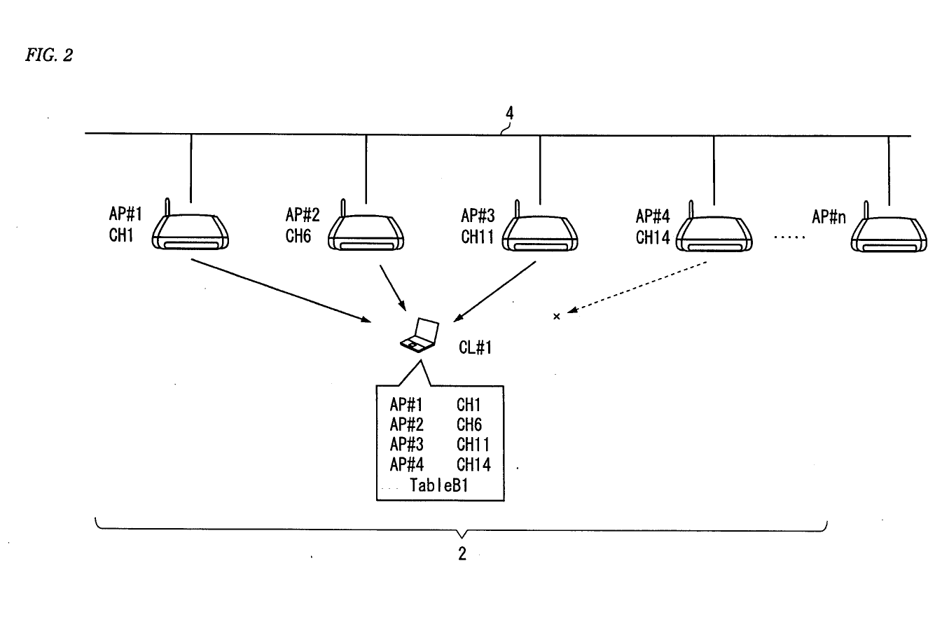

Next, description will be made of access point(s) and CH(s) which are targeted for scanning, with reference to FIG. 2. FIG. 2 is a connection relationship diagram of a client connected with the access points of the wireless LAN system 2. In FIG. 2, parts that are the same parts as in FIG. 1 are given the same reference numerals.

The access points AP#1, AP#2, . . . AP#n are all in an operational state. However, the client CL#1 receives information of the access points AP#1, . . . AP#3, indicating a strength of signals received from the access points AP#1, AP#2, . . . AP#n exceeds a certain threshold value. That is, the table does not store information of the access points AP#4, . . . AP#n receiving the signal whose strength is less than the certain threshold value. Therefore, of the information of the table A1, A2, . . . An, information which is received by the client CL#1 is the information of the table A1, . . . A3.

Next, the client CL#1 performs a logical sum operation using the information of the received table A1 . . . A3 and makes a table B as a result of scanning of a surrounding area of the client CL#1. Accordingly, in the example of FIG. 2, the client CL#1 makes (creates) table B storing corresponding information of the access point AP#1 and channel CH1, access point AP#2 and channel CH6, access point AP#3 and channel CH11, and access point AP#4 and channel CH14.

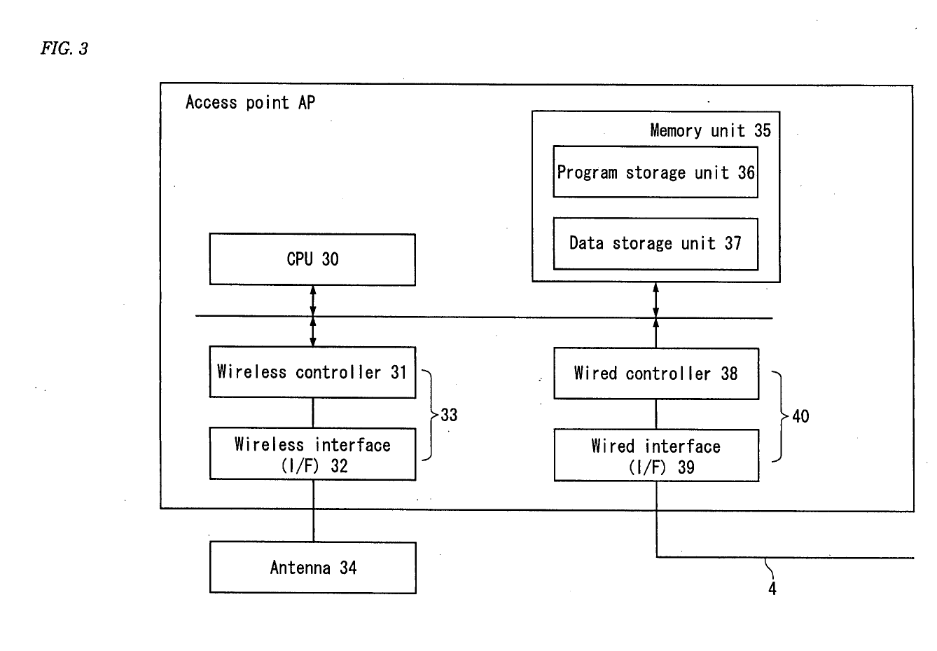

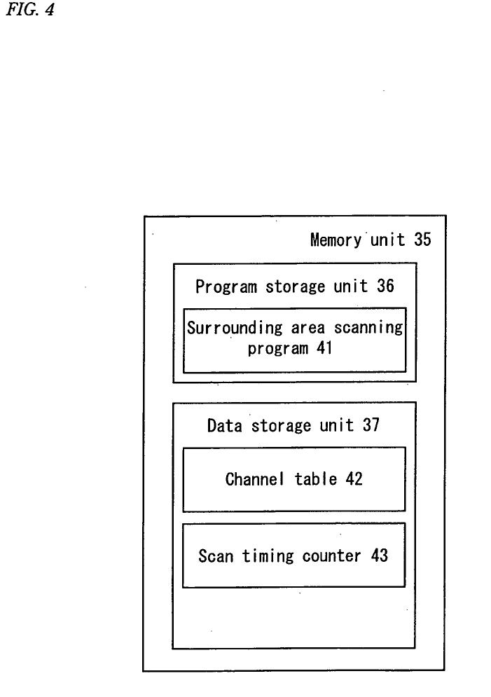

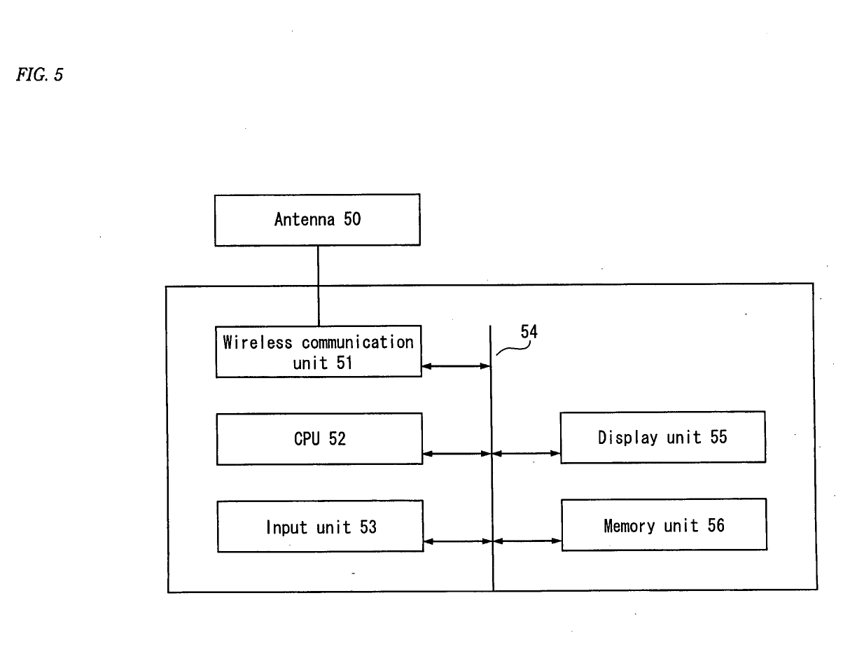

FIG. 3 shows a configuration diagram of an access point. FIG. 4 shows a configuration diagram of a memory unit of an access point. FIG. 5 shows a configuration diagram of a client. In FIG. 3 and FIG. 4, parts previously described are given the same reference numerals.

As shown in FIG. 3, the access point includes a wireless LAN unit 33 as a wireless communication unit, a wired LAN unit 40 as a wired communication unit, a CPU (Central Processing Unit) as a control unit or processing unit, and a memory unit 35 and these units are connected by way of a bus. The wireless LAN unit 33 is controlled by the CPU 30 and performs processing including notifying a client (CL) of information.

The wireless LAN unit 33 is wirelessly connected to the client described above under control of the CPU 30 and includes a wireless controller 31 and a wireless interface unit (I/F) 32. The wireless interface unit 32 is connected with an antenna 33. The wireless controller 31, under control of the CPU 30, controls the wireless interface unit 32. The wireless interface unit 32 transmits and receives an electric wave of a frequency used by the wireless LAN through an antenna 34 and performs data communication by connecting wirelessly to the client.

The wired LAN unit 40, including a wired controller 38 and a wired interface unit (I/F) 39, is controlled by the CPU 30 and performs data communication with other access point(s) (AP) connected thereto. The wired controller 38, under control of the CPU 30, controls the wired interface unit 39. The wired interface unit 39, including a transmitting unit and a receiving unit (not shown), is wired-connected to the other access points through the LAN cable 4.

The CPU 30 is a control unit (processing unit) and performs or executes a scanning program of a surrounding area stored in the memory unit 35. The CPU 30 performs scanning processing of all of the CHs, making (creating) processing of table A storing information of access point(s) (AP) existing in the surrounding area and of the connectable CH, connecting processing, disconnecting processing and the like.

The memory unit 35 is a recording medium storing a scanning program of the surrounding area, the table A which is given the making processing, a number of connected clients and the like, and includes a program storage unit 36 and a data storage unit 37, storing various kinds of program and data.

FIG. 4 shows a configuration diagram of a memory unit of an access point. As shown in FIG. 4, the program storage unit 36 stores a surrounding area scanning program 41, and the data storage unit 37 contains a channel table 42 storing information of each connectable channel, a scan timing counter 43 setting a scan timing corresponding to a CH and the like.

In such configuration, the CPU 30 of the access point performs scanning processing of all the CHs by performing (executing) the surrounding area scanning program 41 stored in the memory unit 35. The memory unit 35 of the access point performs operation(s) in such a way that the CPU 30 performs operation(s) pertaining to the scan timing counter 43 and temporarily stores information resulting from a scanning processing in a channel table 42. In this case, the scan information of which the access point notifies the client shows the CH information which can be received by the client from the access point. That is, the scan information is the table A which is previously described. The access point notifies the client of the information of the table A.

FIG. 5 shows a configuration diagram of a client. As shown in FIG. 5, the client includes a wireless communication unit 51, a CPU 52 as a control unit, an input unit 53, a display unit 55, and a memory unit 56, part or all of which may be connected by way of a bus 54. The wireless communication unit 51 includes a receiving unit and a transmitting unit (not shown) which perform data communication at a frequency used by a wireless LAN through an antenna 50. The client receives scan information as notified by the access point. Also, the client transmits a scan request of a channel based on the scan information. By performing execution of the program stored in the memory unit 56, the CPU 52 controls various functional units such as the wireless communication unit 51 and performs processing of the table B based on the notified scan information and connecting processing. The display unit 55 displays various states such as a communication state and input and output information. The input unit 53 is used for inputting, etc., of various kinds of data as object of the data communication.

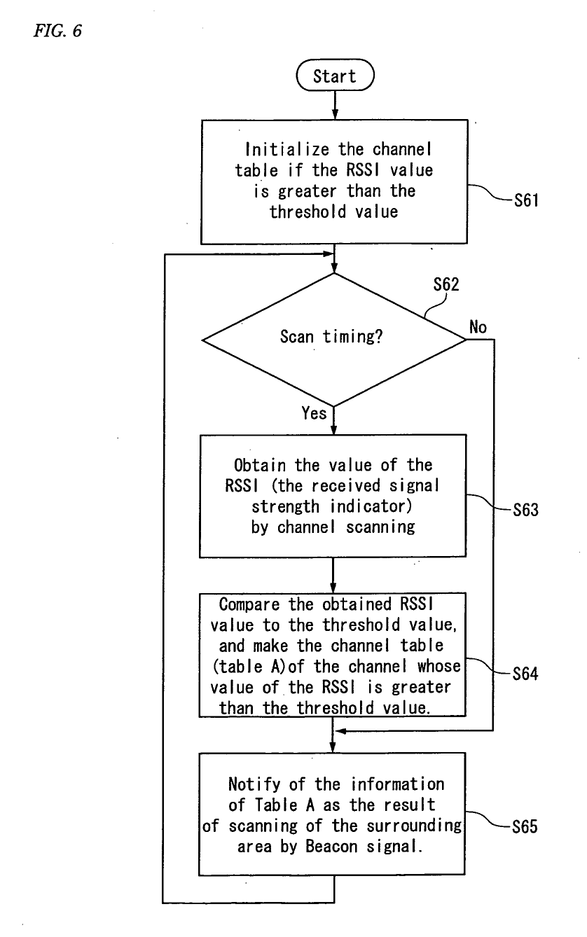

FIG. 6 is a flow chart showing a processing procedure of an access point. Description will be made of a processing procedure of the surrounding area scanning program 40 of the wireless LAN system 2, with reference to FIG. 6.

The access point initializes the channel table 42 (table A) which is to be stored in the memory unit 35. At the time of initializing the channel table 42 (table A), determination is made of whether or not a value of a received signal strength indicator (RSSI) received from the access point is greater than a predetermined threshold value TH. In the present embodiment, the channel is targeted for initialization if the received signal strength indicator (RSSI) value>the predetermined threshold value TH (operation S61).

Next, the access point determines whether or not it is a scan timing (operation S62). The scan timing is not determined during the time the client is scanning for beacon signals and the time the access point is connecting to the client.

When determining that it is the scan timing, the access point obtains the value of the received signal strength indicator (RSSI) by channel scanning (operation S63).

The access point compares the obtained value of the received signal strength indicator (RSSI) to the predetermined threshold value TH. Based on a result of the comparison, access point(s) having the channel whose value of the received signal strength indicator (RSSI) is greater than the predetermined threshold value TH as the channel information, and makes the channel table 42 (table A) (operation S64).

The access point notifies the client, by the beacon signal, of the information of the channel table 42 (table A) as the result of scanning of the surrounding area (operation S65). In operation S62, if the scan timing is not determined, the client is notified, by the beacon signal, of the information of the channel table 42 (table A) initialized in operation S61 as the result of scanning of the surrounding area (operation S65).

If the client is notified of the information of the channel table 42 (table A), the process goes back to operation S62 and the access point determines whether or not it is the scan timing.

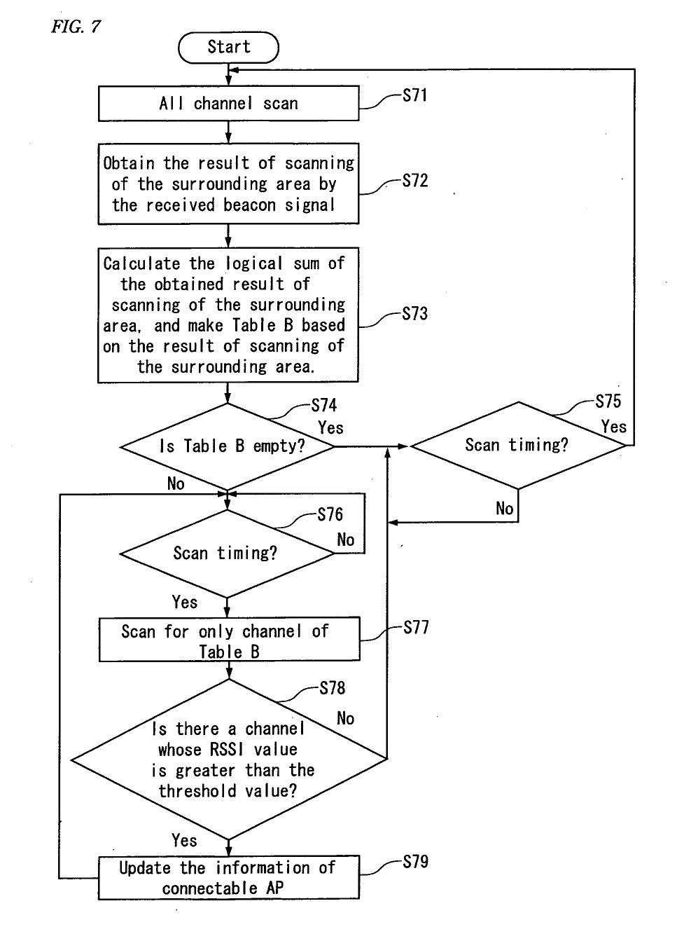

FIG. 7 is a flow chart showing a processing procedure of a client. Description will be made of the processing procedure of the client of the wireless LAN system 2, with reference to FIG. 7. The client sequentially scans for the beacon signals of all of the CHs and receives an electric wave of connectable CH(s) (operation S71).

At this time, by the received beacon signal, the client obtains a result of scanning of the surrounding area made by the access point (operation S72).

In this case, the result of scanning of the surrounding area is the channel table 42 (table A) made by the access point. The channel table 42 (table A) stores the information of the access point and the channel.

The client calculates a result of scanning of the surrounding area, that is, a logical sum of the information of the channel table 42 (table A) received from each access point. The CPU 52 of the client makes the previously described table B of FIG. 2 based on the information of the calculation (operation S73).

Next, the client determines whether or not the table B is empty (operation S74).

If the client determines that the information in the table B is empty, the client determines whether or not it is the scan timing of the access point (operation S75). In this case, the scan timing is not determined during the time the client is scanning the beacon signals and the time the access point is connecting to the client.

If the client determines that it is the scan timing of the access point, the process goes back to operation S71.

If the scan timing is not determined in operation S75, the client stands by for the scan timing of the access point.

Next, in operation S74, if the client CL determines that there is information in the table B, the client determines whether or not it is the scan timing of the access point (operation S76). If the scan timing is not determined in operation S76, the client stands by for the scan timing.

In operation S76, if the client CL determines that it is the scan timing of the access point (A)P, the client performs a scanning of only channel(s) shown by the channel information in the table B (operation S77).

As for the scanned channels, the client determines whether or not the RSSI value is greater than the predetermined threshold value TH (operation S78).

The client accepts the channel as a connectable channel if the RSSI value is determined to be greater than the predetermined threshold value and receives an electric wave of the channel. The client updates the information of the access point and the channel which can be connected to the access point existing in the surrounding area and is wirelessly-connected to the access point (operation S79).

The client wirelessly connected to the access point goes back to operation S76 and determines whether or not it is the scan timing.

If the access point is connected by wireless to a plurality of the clients, the access point is connected by wireless to each of the plurality of the clients.

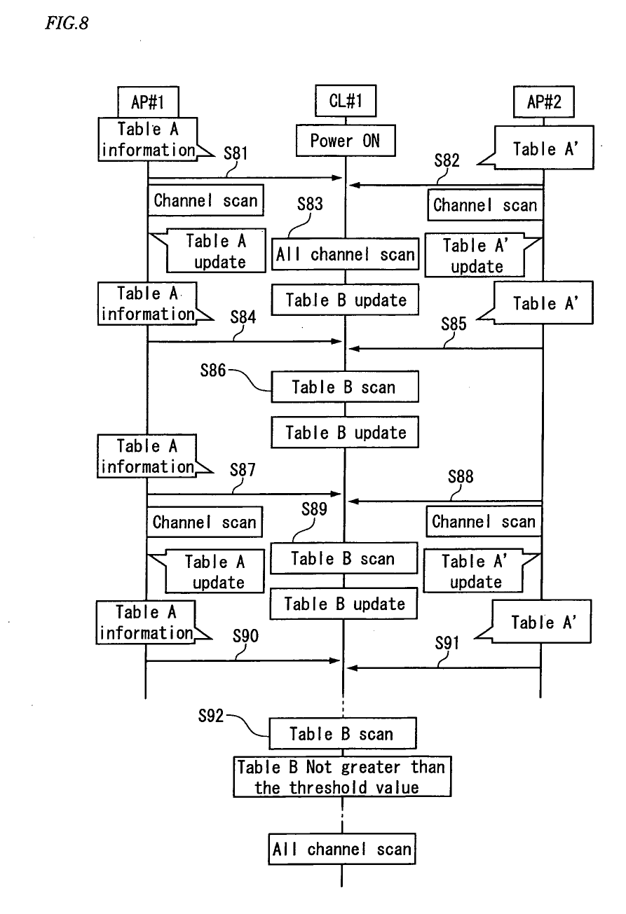

FIG. 8 is a diagram showing an operational sequence of a client and an access point. As shown in the previously-described FIG. 1, the client CL#1 is connected wirelessly to the access points AP#1, AP#2, and AP#3. In this case, as shown in FIG. 8, description will be made of the operational sequence of performing a channel scanning every time an access point transmits twice the beacon signal to the client.

The access point AP#1 scans for all of the CHs and creates table A storing the information of CH(s) which can be connected with access point(s) existing in the surrounding area of the access point AP#1. At this time, if there is a change in the information of the table A, the access point AP#1 updates the table A. The access point AP#1 notifies the client CL#1, by the beacon signal, of information of the channel table 42 which is to be stored in the memory unit 53 as a result of scanning of the surrounding area (operation S81).

In the same way, the access point AP#2 scans for all of the CHs and creates a table A′ storing information of the CH(s) which can be connected with access point(s) existing in a surrounding area of the access point AP#2. At this time, if there is a change in the table A′, the access point AP#2 updates the table A′. The access point AP#2 notifies the client CL#1, by the beacon signal, of the information of the channel table 42 (table A′) which is to be stored in the memory 35 of the access point AP#2 as a result of scanning of the surrounding area (operation S82).

The powered-on client CL#1 sequentially scans for the beacon signals of all of the CHs and receives an electric wave of the connectable CH. In this case, the client CL#1 obtains the channel table 42 (tables A and A′) which is the result, made (created) by each access point, of scanning of the surrounding area. The client CL#1 calculates the obtained result of scanning of the surrounding area, that is, the logical sum of the information of the table A of the access point AP#1 and the information of the table A′ of the access point AP#2. The CPU 52 of the client CL#1 makes the table B based on the calculated information. At this time, if there is a change in the table B made in this case in comparison with the previously made table B stored in the memory unit 56, the client CL#1 updates the table B (operation S83).

Next, the access points AP#1 and AP#2 notify the client CL#1, by the beacon signal, of the information of the previously made tables A and A′ at regular time intervals (operation S84, operation S85).

The client CL#1 sequentially scans for the beacon signals of the CH in the table B calculated by the logical sum of the information, which is the result of scanning of the surrounding area made in each access point, of the channel table 42 (tables A and A′) and receives an electric wave of the connectable CH. In this case, if there is a change in the table B made in this case in comparison with the table B made in operation S83, the client CL#1 updates the table B (operation S86).

As mentioned above, FIG. 8 is a diagram showing the operational sequence of performing the channel scanning every time the access point transmits twice the beacon signal to the client.

Therefore, the access point AP#1 scans for all of the CHs and makes (creates) the table A storing the information of the CH which can be connected to the access point existing in the surrounding area. In this case, if there is a change in the information of the table A, the access point AP#1 updates the table A. The access point AP#1 notifies the client CL#1, by the beacon signal, of the information of the channel table 42 (table A) which is to be stored in the memory unit 35 of the access point AP#1 as the result of scanning of the surrounding area (operation S87).

In the same way, the access point AP #2 scans for all of the CHs and updates the table A′ if there is a change in the information of the table A′ for storing the information of the CH which can be connected to the access point existing in the surrounding area of the access point AP #2. The access point AP#2 notifies the client CL#1, by the beacon signal, of the information of the channel table 42 (table A′) which is to be stored in the memory 35 of the access point AP#2 (operation S88).

The client CL#1 sequentially scans for the beacon signals of the CH of the table B calculated by the logical sum of the information of the channel table 42 (tables A and A′), which is the result of scanning of the surrounding area made in each access point, and receives an electric wave of the connectable CH. At this time, if there is a change in the information of the table B made in this case in comparison with the table B made in operation S86, the client CL#1 updates the table B (operation S89).

Next, the access points AP#1 and AP#2 notify the client CL#1, by the beacon signal, of the information of the previously made tables A and A′ at regular time intervals (operation S90, operation S91).

The client CL#1 sequentially scans for the beacon signals of the CH of the table B calculated by the logical sum of the information of the channel table 42 (tables A and A′), which is the result of scanning of the surrounding area made in each access point, and receives an electric wave of the connectable CH. In this case, if there is a change in the information of the table B made in this case in comparison with the previously made table B, the client CL#1 updates the table B (operation S92).

At this time, at the time of receiving an electric wave of the connectable CH in the table B, the client CL#1 determines the strength of the electric wave of the CH. The CH may be a connectable CH if the strength of the electric wave of the CH which is greater than the predetermined threshold value.

In this way, the client CL#1 obtains the information of the CH which can be connected to the access points AP#1, AP#2, and the access point existing in the surrounding area.

The above-described embodiment uses a wireless LAN module which is applied to the wireless LAN as a wireless communication module. However, the wireless communication module of the present invention is not limited to the above description and may include module capable of switching communication to a plurality of the access points. Also, in the above-described embodiment, a notebook style computer is applied as a computer device. However, the computer device is not limited to the above description and any device capable of transmitting and receiving data through a wireless module is applicable. For example, the computer device can be composed of a mobile electronic device such as a PDA (Personal Digital Assistant), a game machine, a mobile phone or the like.

With this arrangement, there is no need for the client to scan for all of the CHs at all times, so that the scanning time can be reduced by scanning only necessary CHs. If scanning time is reduced, more time is allowed for transmission and reception of data. As a result, it is possible to achieve efficient band usage.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A communication system having a plurality of communication apparatuses and a mobile apparatus connected with a communication apparatus, comprising:
the communication apparatus including:
a scanning unit scanning for all channels;
a specifying unit specifying, based on a result of said scanning, at least one other communication apparatus wirelessly connectable and a channel for a wireless connection to said other communication apparatus;
a processing unit creating a table based on information of said other communication apparatus and the channel that is specified by the specifying unit and information of said communication apparatus and a channel for a corresponding wireless connection; and
a transmitting unit transmitting the table to the mobile apparatus, and
wherein the mobile apparatus receives the table transmitted from the communication apparatus and wirelessly connects the channel to the other communication apparatus of the table received.

2. The communication system according to claim 1, wherein the mobile apparatus performs a logical sum operation based on tables transmitted respectively from said plurality of the communication apparatuses, and wirelessly connects a channel to the other communication apparatus of the table on which the logical sum operation is performed.

3. The communication system according to claim 2, wherein the communication apparatus determines a strength of an electric wave of the channel, and targets a channel determined to have a strength that is greater than a predetermined value.

4. A mobile apparatus connected with a plurality of communication apparatuses, comprising:
a communication unit receiving a table based on corresponding information of at least one other communication apparatus and a channel determined to be wirelessly connectable to said other communication apparatus and corresponding information of a communication apparatus and a channel that is wirelessly connectable to the communication apparatus; and
a control unit wirelessly connecting the channel to the other communication apparatus indicated in the table received.

5. The mobile apparatus according to claim 4, comprising:
performing a logical sum operation on tables transmitted respectively from a plurality of the communication apparatuses, and
wirelessly connecting the channel to the other communication apparatus of the table received.

6. A communication method of a communication system having a plurality of communication apparatuses and a mobile apparatus that is connected with a communication apparatus, comprising:
the communication apparatus executes operations including:
scanning for all channels;
specifying, based on a result of said scanning, at least one other communication apparatus that is wirelessly connectable and a channel for a wireless connection to said other communication apparatus;
making a table based on information of said other communication apparatus and the channel specified and information of said communication apparatus and a channel wirelessly connectable to the said communication apparatus; and
transmitting the table to the mobile apparatus,
wherein the mobile apparatus executes operations including:
receiving the table transmitted from the communication apparatus; and
connecting the channel to the other communication apparatus of the table received.

7. The communication method according to claim 6, wherein the mobile apparatus performs a logical sum operation on tables transmitted respectively from said plurality of the communication apparatuses and controls a wireless connection by a channel to the other communication apparatus of the table on which the logical sum operation performed.

8. The communication method according to claim 7, wherein the communication apparatus determines a strength of an electric wave of the channel, a channel that is determined to have a strength of an electric wave that is greater than a predetermined threshold value is targeted.

9. A computer-readable recording medium having thereon stored a program to cause a mobile apparatus to execute operations, comprising:
receiving, from the communication apparatus, a table based on corresponding information of at least one other communication apparatus and a channel determined to be wirelessly connectable to said other communication apparatus and corresponding information of a communication apparatus and a channel that is wirelessly connectable to the communication apparatus; and
controlling wireless connection of the channel to the communication apparatus of the table received.

10. The computer-readable recording medium according to claim 9, further comprising:
performing a logical sum operation using tables transmitted respectively from a plurality of the communication apparatuses,
wherein the controlling is performed to wirelessly connect a channel to the other communication apparatus of the table on which the logical sum operation is performed.

11. A method of communication between at least one of a plurality of communication apparatuses and a mobile apparatus, comprising:
transmitting tables having information of channels wirelessly connectable to said mobile apparatus as a result of scanning of all channels; and
connecting with a channel among said channels indicated in said tables when said channel indicates a signal greater than a predetermined value in response to a scanning of said channels in the table.
